(19) United States
(12) Patent Application Publication
(10) Pub. No.: US 2009/0308188 A1
(43) Pub. Date: Dec. 17, 2009

(54) Robot joint driving apparatus and robot having the same

(75) Inventors: Soo Sang Yang, Suwon-si (KR); Yeon Taek Oh, Yongin-si (KR); Youn Baek Lee, Suwon-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 12/382,002

(22) Filed: Mar. 5, 2009

(30) Foreign Application Priority Data
Jun. 11, 2008 (KR) 10-2008-54851

(51) Int. Cl. F16H 25/20; F16H 25/22

(52) U.S. Cl. 74/89.27

(57) ABSTRACT

Disclosed are a robot joint driving apparatus and a robot having the same. The robot joint driving apparatus includes a driving motor being rotatable in forward and reverse directions; a pair of movable members connected to the driving motor, and moving rectilinearly in mutually opposite directions according to the rotation of the driving motor; a wire provided with both ends respectively connected to the pair of movable members; and a joint unit, on which the wire is wound, driven by the movement of the wire.

### CROSS-REFERENCE TO RELATED APPLICATIONS

This application claims the benefit of Korean Patent Application No. 2008-0054851, filed on Jun. 11, 2008, in the Korean Intellectual Property Office, the disclosure of which is incorporated herein by reference.

### BACKGROUND

1. Field

The present invention relates to a robot joint driving apparatus and a robot having the same, and more particularly to a robot joint driving apparatus, which has an improved joint driving structure, and a robot having the robot joint driving apparatus.

2. Description of the Related Art

Robots having various shapes, which can carry out biped walking, quadruped walking, etc., have been developed for home, military and industrial purposes.

The above robots perform various motions including a walking motion, such as running or walking, through movement of joints.

Joint driving methods are divided into a joint driving method using a motor and a speed reducer connected to the motor and a joint driving method using a wire.

The joint driving method using the speed reducer has problems, such as limited disposition of a driving apparatus, the generation of relatively high noise during the driving of the apparatus, and a complicated structure.

The joint driving method using a wire solves the above problems caused by the joint driving method using the speed reducer, and thus has been now introduced.

In one example of the joint driving method using a wire, actuators having the same structure as that of a human muscle are provided, and a wire is wound on a pulley connected to a motor such that a joint, rotatably installed, is rotated and thus a link connected to the joint is operated.

A conventional joint driving apparatus using the above joint driving method using the wire requires a pair of actuators for each of joints to drive the respective joints similarly to the motion of a human muscle. Further, in order to perform a designated motion, a pair of the actuators must be controlled synchronously.

Further, the conventional joint driving apparatus requires a separate control unit to uniformly maintain the tensile strength of a wire connecting the pair of the actuators and the joint.

### SUMMARY

Therefore, one aspect of the present invention is to provide a robot joint driving apparatus, which minimizes the number of actuators to drive a joint, and a robot having the same.

Another aspect of the present invention is to provide a robot joint driving apparatus, which is easily controlled using a wire, and a robot having the same.

Yet another aspect of the present invention is to provide a robot joint driving apparatus, which uniformly maintains the tensile strength of a wire, and a robot having the same.

Additional aspects and/or advantages will be set forth in part in the description which follows and, in part, will be apparent from the description, or may be learned by practice of the invention.

The foregoing and/or other aspects and advantages of the present invention are achieved by providing a robot joint driving apparatus including a driving motor being rotatable in forward and reverse directions; a pair of movable members connected to the driving motor, and moving rectilinearly in mutually opposite directions according to the rotation of the driving motor; a wire provided with both ends of the wire being respectively connected to the pair of movable members; and a joint unit, on which the wire is wound, driven by the movement of the wire.

The robot joint driving apparatus may further include a pair of ball screw units, and each of the pair of movable members may be connected to each of the pair of ball screw units. The robot joint driving apparatus may further include guide units guiding the rectilinear movement of the pair of movable members.

The guide units may respectively include sub ball screw units geared with the pair of ball screw units, and the pair of movable members may be screw-connected to the sub ball screw units. The guide units may respectively include guide bars disposed in parallel with the pair of ball screw units, and the guide bars may guide the sliding movement of the pair of movable members.

The pair of ball screw units may be geared with the driving motor, and be rotated according to the driving of the driving motor. The robot joint driving apparatus may further include a belt unit to transmit the driving force of the driving motor to the pair of ball screw units.

The foregoing and/or other aspects and advantages of the present invention are achieved by providing a robot joint driving apparatus including a driving unit including a driving motor and a gear unit connected to the driving motor; a pair of ball screw units in movable contact with the gear unit; a pair of movable members respectively provided at the pair of ball screw units, and moving rectilinearly in mutually opposite directions according to the rotation of the driving motor; a wire provided with both ends of the wire being respectively connected to the pair of movable members, and moving according to the movement of the pair of movable members; and a joint unit driven by the movement of the wire.

The wire may surround one side of the outer circumferential surface of the joint unit while maintaining a designated tensile force. The robot joint driving apparatus may further include guide units guiding the rectilinear movement of the pair of movable members.

The guide units may respectively include sub ball screw units geared with the pair of ball screw units, and the pair of movable members may be screw-connected to the sub ball screw units. The guide units may respectively include guide bars disposed in parallel with the pair of ball screw units, and the guide bars may guide the sliding movement of the pair of movable members.

The foregoing and/or other aspects and advantages of the present invention are achieved by providing a robot joint driving apparatus including a driving motor being rotatable in first and second directions; a first ball screw unit provided with a first movable member connected to the driving motor, and moving rectilinearly according to the rotation of the driving motor in a first direction; a second ball screw unit provided with a second movable member connected to the driving motor, and moving rectilinearly in a direction opposite to the direction of the movement of the first movable member according to the rotation of the driving motor in the first direction; a wire connected to the first and second movable members; and a joint unit rotatably connected to the wire according to the movement of the wire, and rotated according to the driving of the driving motor.

The foregoing and/or other aspects and advantages of the present invention are achieved by providing a robot including a joint unit, and a joint driving apparatus to drive the joint unit, the joint driving apparatus including a driving motor; a pair of movable members connected to the driving motor, and moving rectilinearly in mutually opposite directions according to the rotation of the driving motor; and a wire connecting the pair of movable members and the joint unit to rotate the joint unit according to the movement of the pair of movable members while maintaining a designated tensile force.

Each of the at least one joint driving apparatuses may further include a pair of ball screw units, and each of the pair of movable members may be connected to each of the pair of ball screw units. Each of the at least one joint driving apparatuses may further include guide units guiding the rectilinear movement of the pair of movable members.

The guide units may respectively include sub ball screw units geared with the pair of ball screw units, and the pair of movable members may be screw-connected to the sub ball screw units. The guide units may respectively include guide bars disposed in parallel with the pair of ball screw units, and the guide bars may guide the sliding movement of the pair of movable members. The pair of ball screw units may be geared with the driving motor, and be rotated according to the driving of the driving motor.

Each of the at least one joint driving apparatus may further include a belt unit to transmit the driving force of the driving motor to the pair of ball screw units.

The foregoing and/or other aspects of the present invention are achieved by providing a robot including a joint unit, and a joint driving apparatus to drive the one joint unit, the first joint driving apparatus including a driving motor being rotatable in first and second directions; a first ball screw unit provided with a first movable member connected to the driving motor and moving rectilinearly according to the rotation of the driving motor in the first direction; a second ball screw unit provided with a second movable member connected to the driving motor and moving rectilinearly in a direction opposite to the direction of movement of the first movable member according to the rotation of the driving motor in the first direction; and a wire connected to the first and second movable members, wherein each of the joint units is rotatably connected to the wire according to the movement of the wire, and is rotated according to the driving of the driving motor.

### BRIEF DESCRIPTION OF THE DRAWINGS

These and/or other aspects and advantages of the invention will become apparent and more readily appreciated from the following description of the embodiments, taken in conjunction with the accompanying drawings in which:

FIG. 1 is a view illustrating the external appearance of a humanoid robot in accordance with one embodiment of the present invention;

FIG. 2 is a schematic view illustrating the constitution of the humanoid robot of FIG. 1;

FIG. 3 is a perspective view illustrating a knee joint driving apparatus in accordance with one embodiment of the present invention;

FIG. 4 is a view illustrating the operation of the knee joint driving apparatus of FIG. 3;

FIG. 5 is a perspective view illustrating a knee joint driving apparatus in accordance with another embodiment of the present invention; and

FIG. 6 is a perspective view illustrating an ankle joint driving apparatus in accordance with one embodiment of the present invention.

### DETAILED DESCRIPTION OF EMBODIMENTS

Reference will now be made in detail to the embodiments of the present invention, examples of which are illustrated in the accompanying drawings, wherein like reference numerals refer to like elements throughout. The embodiments are described below to explain the present invention by referring to the annexed drawings.

The present invention may be applied to robots having various shapes, but a humanoid robot will be exemplarily described below.

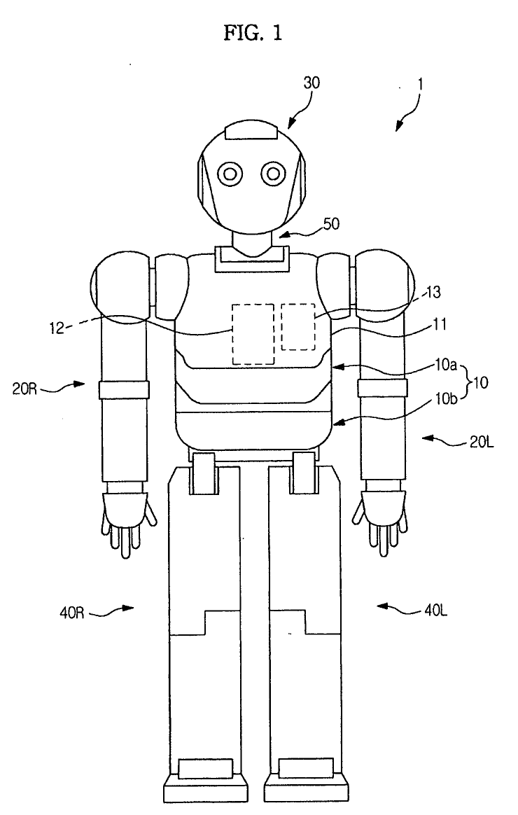

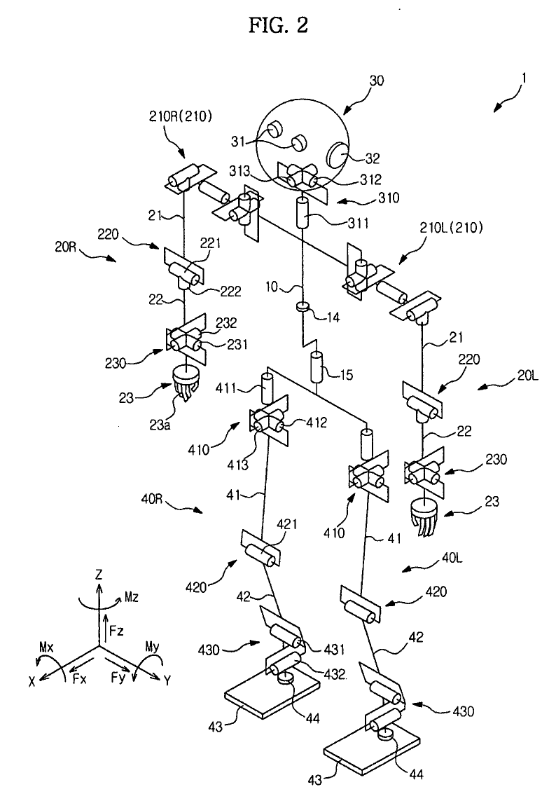

FIG. 1 is a view illustrating the external appearance of a humanoid robot in accordance with one embodiment of the present invention, and FIG. 2 is a schematic view illustrating the constitution of the humanoid robot of FIG. 1.

As shown in FIGS. 1 and 2, a humanoid robot (hereinafter, briefly referred to as a ‘robot’) 1 includes a trunk 10, arms 20R and 20L respectively connected to both sides of the upper portion of the trunk 10, a head 30 connected to the upper end of the trunk 10, and legs 40R and 40L respectively connected to both sides of the lower portion of the trunk 10. The two arms 20R and 20L are respectively connected to the trunk 10 through shoulder joint assemblies 210R and 210L, and the head 30 is connected to the trunk 10 through a neck 50. Here, L represents the left side of the robot 1, and R represents the right side of the robot 1.

The inside of the trunk 10 is protected by a cover 11. A control unit 12, a battery 13, and a tilt sensor 14 (with reference to FIG. 2) are installed in the trunk 10. The tilt sensor 14 detects a tilt angle of the trunk 10 relative to a vertical axis, an angular velocity of the trunk 10, etc.

The trunk 10 is divided into a breast part 10a and a waist part 10b, and a joint 15 to rotate the breast part 10a on the waist part 10b is installed between the breast part 10a and the waist part 10b. FIG. 2 briefly illustrates the trunk 10 as a trunk link.

Both arms 20R and 20L respectively include upper arm links 21, lower arm links 22, and hands 23. The upper arm links 21 are respectively connected to the trunk 10 through the shoulder joint assemblies 210. The upper arm links 21 and the lower arm links 22 are respectively connected to each other through elbow joint assemblies 220, and the lower arm links 22 and the hands 23 are respectively connected to each other by wrist joint assemblies 230.

The elbow joint assemblies 220 respectively include rotary joints 221 in a pitch direction and rotary joints 222 in a yaw direction, and thus have 2 degree of freedom. The wrist joint assemblies 230 respectively include rotary joints 231 in the pitch direction and rotary joints 232 in a roll direction, and thus have 2 degrees of freedom.

Five fingers 23a are respectively installed at the hands 23. A plurality of joints (not shown), each of which is driven by a motor, are respectively installed on the fingers 23a. The fingers 23a interlock with the motion of the arms 20R and 20L, and perform various motions, such as gripping an object or pointing out a specific direction.

The shoulder joint assemblies 210R and 210L are mounted at both sides of the trunk 10, and connect both arms 20R and 20L to the trunk 10. The two shoulder joint assemblies 210R and 210L are disposed between the trunk 10 and the arms 20R and 20L of the robot 1, and move the arms 20R and 20L.

Cameras 31 serving as eyes of the robot 1 and microphones 32 serving as ears of the robot 1 are installed on the head 30.

The head 30 is connected to the trunk 10 by a neck joint unit 310. The neck joint unit 310 includes a rotary joint 311 in the yaw direction, a rotary joint 312 in the pitch direction, and a rotary joint 313 in the roll direction, and thus has 3 degrees of freedom.

Motors (not shown) for rotating the head 30 are respectively connected to the rotary joints 311, 312, and 313 of the neck joint unit 310. The control unit 12 controls the respective motors to drive the rotary joints 311, 312, and 313 at proper angles, thus moving the head 30 in a desired direction.

Both legs 40R and 40L respectively include thigh links 41, calf links 42, and the feet 43. The thigh links 41 are respectively connected to the trunk 10 through thigh joint units 410. The thigh links 41 and the calf links 42 are respectively connected to each other by knee joint units 420, and the calf links 42 and the feet 43 are respectively connected to each other by ankle joint units 430.

The thigh joint units 410 have 3 degrees of freedom. Specifically, the thigh joint units 410 respectively include rotary joints 411 in the yaw direction (on the z-axis), rotary joints 412 in the pitch direction (on the y-axis), and rotary joints 413 in the roll direction (on the x-axis).

The knee joint units 420 respectively include rotary joints 421 in the pitch direction, and thus have 1 degree of freedom. The ankle joint units 430 respectively include rotary joints 431 in the pitch direction and rotary joints 432 in the roll direction, and thus have 2 degrees of freedom.

Since each of the two legs 40R and 40L includes six rotary joints of three joint units 410, 420 and 430, as described above, the two legs 40R and 40L include twelve rotary joints. Although not shown in the drawings, motors to respectively drive the respective rotary joints are installed on each of the legs 40R and 40L. The control unit 12 properly controls the motors provided on the legs 40R and 40L, thus performing various motions of the legs 40R and 40L, including a walking motion of the robot 1.

Multi-axis force and torque (F/T) sensors 44 are respectively installed between the feet 43 and the ankle joint units 430 of the two legs 40R and 40L. The multi-axis F/T sensors 44 measure three-directional components (Mx, My, Mz) of moment and three-directional components (Fx, Fy, Fz) of force transmitted from the feet 43, and thus detect whether or not the feet 43 land and a load applied to the feet 43.

A joint driving apparatus 500 to drive each of the respective joints is provided in the above-described robot.

Although the joint driving apparatus 500 is applied to various joints, such as arms, legs, a neck, etc., the joint driving apparatus 500, which is applied to a knee joint unit and an ankle joint unit of a leg, will be exemplarily described below.

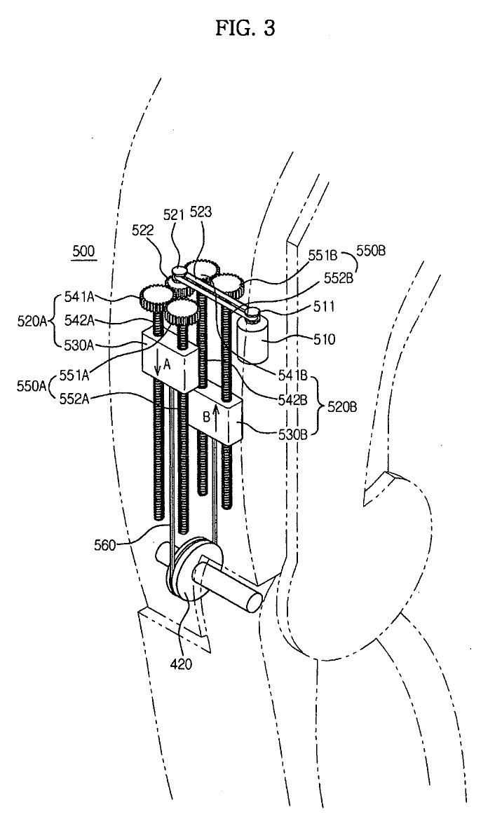

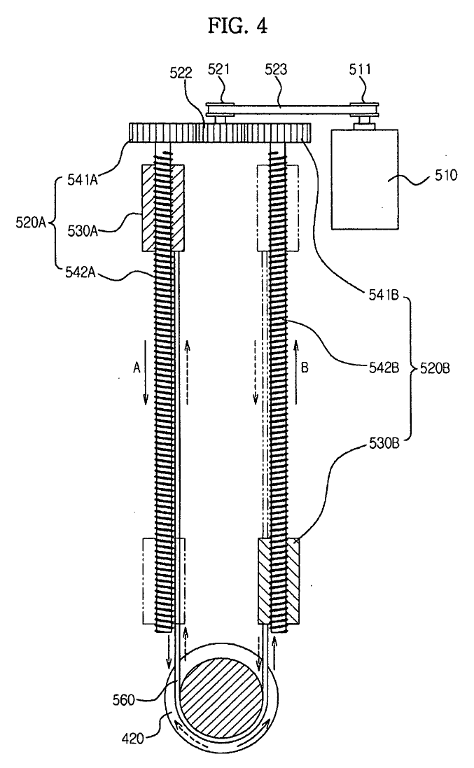

FIG. 3 is a perspective view illustrating a knee joint driving apparatus in accordance with one embodiment of the present invention, and FIG. 4 is a view illustrating the operation of the knee joint driving apparatus of FIG. 3.

The joint driving apparatus 500, as shown in FIG. 3, includes a driving motor 510 rotated in regular and reverse directions, ball screw devices 520A and 520B provided with a pair of movable members 530A and 530B, which are connected to the driving motor 510 and moves rectilinearly according to the rotation of the driving motor 510, a wire 560 connecting the pair of the movable members 530A and 530B, and the knee joint unit 420 rotatably connected to the wire 560 according to the movement of the wire 560 and rotated according to the driving of the driving motor 510.

The driving motor 510 is capable of being rotated in forward and reverse directions, and a motor pulley 511 is provided at a rotary shaft of the driving motor 510.

The ball screw devices 520A and 520B are provided with a ball screw pulley 521 to receive the driving force of the driving motor 510, and a driving gear 522 formed integrally with the ball screw pulley 521 to drive the ball screw devices 520A and 520B using the received driving force. A belt unit 523 to transmit the driving force of the driving motor 510 to the ball screw devices 520A and 520B is provided between the motor pulley 511 and the ball screw pulley 521.

The ball screw devices 520A and 520B include a first ball screw device 520A engaged with the driving gear 522 and provided with the first movable member 530A moving rectilinearly in the direction ‘A’, when the driving motor 510 is rotated in the forward direction (the first direction), and a second ball screw device 520B engaged with the driving gear 522 and provided with the second movable member 530B moving rectilinearly in the direction opposite to the moving direction of the first movable member 530A (the direction ‘B’), when the driving motor 510 is rotated in the regular direction (the first direction).

The first ball screw device 520A includes a first gear unit 541A engaged with the driving gear 522, a first ball screw unit 542A formed integrally with the first gear unit 541A and provided with a screw thread formed on the outer circumferential surface thereof, and the first movable member 530A moving vertically along the first ball screw unit 542A according to the rotation of the first ball screw unit 542A.

The second ball screw device 520B includes a second gear unit 541B engaged with the driving gear 522, a second ball screw unit 542B formed integrally with the second gear unit 541B and provided with a screw thread formed on the outer circumferential surface thereof, and the second movable member 530B moving vertically along the second ball screw unit 542B according to the rotation of the second ball screw unit 542B.

The ball screw devices 520A and 520B further include guide units 550A and 550B, which guide the rectilinear movement of the first and second movable members 530A and 530B such the first and second movable members 530A and 530B are not rotated but only move vertically when the first and second ball screw units 542A and 542B are rotated.

The guide units 550A and 550B include first and second guide units 550A and 550B, which are disposed in parallel with the ball screw devices 520A and 520B.

The first guide unit 550A includes a first sub gear unit 551A engaged with the first gear unit 541A, and a first sub ball screw unit 552A formed integrally with the first sub gear unit 551A and provided with a screw thread formed on the outer circumferential surface thereof.

The second guide unit 550B includes a second sub gear unit 551B engaged with the second gear unit 541B, and a second sub ball screw unit 552B formed integrally with the second sub gear unit 551B and provided with a screw thread formed on the outer circumferential surface thereof.

The first ball screw device 520A and the first guide unit 550A form one pair, and the second ball screw device 520B and the second guide unit 550B form another pair.

The first and second movable members 530A and 530B are formed in an approximately rectangular parallelepipedal shape. The first movable member 530A is screw-connected to the first ball screw unit 542A of the first ball screw unit 520A and the first sub ball screw unit 552A of the first guide unit 550A, and the second movable member 530B is screw-connected to the second ball screw unit 542B of the second ball screw unit 520B and the second sub ball screw unit 552B of the second guide unit 550B, and thus the first and second movable members 530A and 530B move only vertically without rotation, when the driving motor 510 is driven.

Here, the first and second movable members 530A and 530B move rectilinearly in the mutually opposite directions. For this reason, the first ball screw unit 542A has a right-hand screw thread, and the second ball screw unit 542B has a left-hand screw thread. Further, the first sub ball screw unit 552A forming a pair with the first ball screw unit 542A has a left-hand screw thread, and the second sub ball screw unit 552B forming a pair with the second ball screw unit 542B has a right-hand screw thread. Thereby, the first and second movable members 530A and 530B can smoothly move in the mutually opposite directions.

Further, the first and second movable members 530A and 530B are screw-connected to the first and second ball screw units 542A and 542B and the first and second sub ball screw units 552A and 552B twice, and thus more stably move when the driving motor 510 is driven.

The wire 560 may be made of steel, and one end of the wire 560 is fixed to the first movable member 530A and the other end of the wire 560 is fixed to the second movable member 530B.

The wire 560 is connected to the knee joint unit 420 while maintaining a designated degree of tensile force to rotate the knee joint unit 420 using the driving force of the driving motor 510, and the middle of the wire 560 surrounds the lower portion of the outer circumferential surface of the disk-shaped knee joint unit 420.

Thus, when the driving motor 510 is rotated in the regular direction, the first movable member 530A moves in the direction ‘A’ along the first ball screw unit 542A and the first sub ball screw unit 552A and the second movable member 420B moves in the direction ‘B’ along the second ball screw unit 542B and the second sub ball screw unit 552B simultaneously, as shown in FIGS. 3 and 4. The wire 560 fixed to the first and second movable members 530A and 530B moves according to the movement of the first and second movable members 530A and 530B, and thus the knee joint unit 420 rotates.

On the other hand, when the driving motor 510 is rotated in the reverse direction, the first and second movable members 530A and 530B respectively move in the reverse directions of the movements of the first and second movable members 530A and 530B when the driving motor 510 is rotated in the regular direction. Then, the wire 560 fixed to the first and second movable members 530A and 530B moves in the reverse direction also, and thus the knee joint unit 420 rotates in the reverse direction.

The above joint driving apparatus in accordance with this embodiment of the present invention stably rotates a joint unit connected to a wire using a single driving motor.

Next, a joint driving apparatus in accordance with another embodiment of the present invention and a robot having the same will be described.

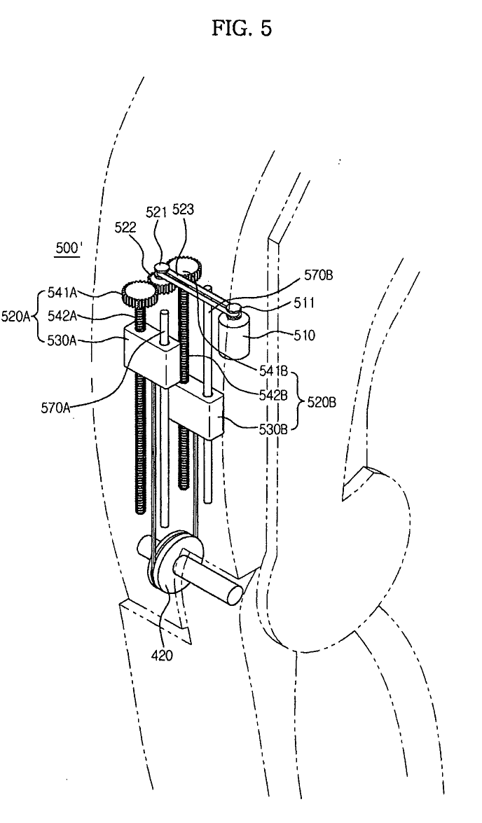

FIG. 5 is a perspective view illustrating a knee joint driving apparatus in accordance with another embodiment of the present invention.

A joint driving apparatus 500′ of this embodiment is substantially the same as that of the knee joint driving apparatus of the earlier embodiment except for guide units.

Some parts in this embodiment, which are substantially the same as those in the earlier embodiment, are denoted by the same reference numerals even though they are depicted in the different drawings, and a detailed description thereof will thus be omitted.

The guide units of the joint driving apparatus 500′ in accordance with this embodiment respectively include first and second guide bars 570A and 570B disposed in parallel with the first and second ball screw units 542A and 542B.

The first and second guide bars 570A and 570B have the same structure, are disposed in parallel with the first and second ball screw units 542A and 542B, and serve to prevent the rotation of the first and second movable members 530A and 530B such that the first and second movable members 530A and 530B can move only rectilinearly, without transmitting power to the first and second ball screw units 542A and 542B. That is, the first and second guide bars 570A and 570B guide the sliding movement of the first and second movable members 530A and 530B.

Thus, the first and second movable members 530A and 530B move only vertically without rotation, when the driving motor 510 is driven.

Next, a joint driving apparatus to drive an ankle joint unit in accordance with one embodiment of the present invention will be described.

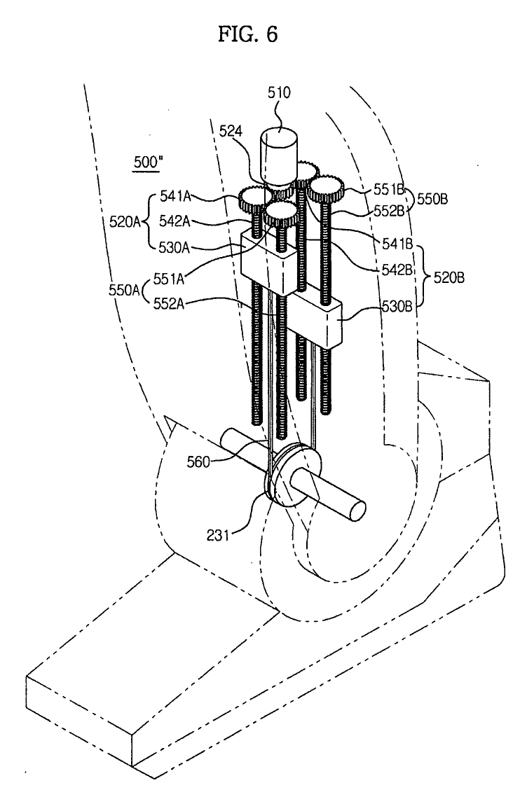

FIG. 6 is a perspective view illustrating an ankle joint driving apparatus in accordance with one embodiment of the present invention.

A joint driving apparatus 500″ to drive an ankle joint unit drives a rotary joint 231 in the pitch direction, and is substantially the same as that of the joint driving apparatus to drive the knee joint unit except for a method of connecting the driving motor 510 and the ball screw devices 520A and 520B.

Some parts of the joint driving apparatus 500″ to drive the ankle joint unit, which are substantially the same as those of the joint driving apparatus to drive the knee joint unit, are denoted by the same reference numerals even though they are depicted in the different drawings, and a detailed description thereof will thus be omitted because it is considered to be unnecessary.

In the joint driving apparatus 500″ to drive the ankle rotary joint 231, a driving motor 510 is rotated in regular and reverse directions, and a driving gear unit 524 is connected directly to a rotary shaft of the driving motor 510.

Since first and second gear units 541A and 541B of ball screw devices 520A and 520B are geared directly with the driving gear unit 524 of the driving motor 510 without any separate gear unit, the driving force of the driving motor 510 is transmitted to the ball screw devices 520A and 520B, and thus the joint driving apparatus 500″ to drive the ankle rotary joint 231 performs the same motion as that of the joint driving apparatus 500 to drive the knee joint unit 420.

Although the above embodiments illustrate that the joint driving apparatus to drive the ankle joint unit and the joint driving apparatus to drive the knee joint unit are separate, the connection between the driving motor and the ball screw devices may be varied according to shape and size of a space to accommodate the joint driving apparatus.

That is, the constitution of the joint driving apparatus to drive the ankle joint unit may be used to drive the knee joint unit, and the constitution of the joint driving apparatus to drive the knee joint unit may be used to drive the ankle joint unit. Further, the joint driving apparatuses in accordance with the embodiments of the present invention may be used to drive other joint units.

As apparent from the above description, the embodiment of the present invention provides a robot joint driving apparatus and a robot having the same, which include a driving motor being rotatable in regular and reverse directions; a pair of movable members moving rectilinearly in mutually opposite directions according to the rotation of the driving motor; a wire respectively connected to the pair of movable members; and a joint unit driven by the movement of the wire, thus driving the joint unit using the single motor and wire.

Although embodiments of the invention have been shown and described, it would be appreciated by those skilled in the art that changes may be made in these embodiments without departing from the principles and spirit of the invention, the scope of which is defined in the claims and their equivalents.

What is claimed is:

1. A robot joint driving apparatus comprising:
a driving motor being rotatable in forward and reverse directions;
a pair of movable members connected to the driving motor, and moving rectilinearly in mutually opposite directions according to the rotation of the driving motor;
a wire provided with both ends of the wire being respectively connected to the pair of movable members; and
a joint unit, on which the wire is wound, driven by movement of the wire.

2. The robot joint driving apparatus according to claim 1, further comprising a pair of ball screw units,
wherein each of the pair of movable members is respectively connected to one of the pair of ball screw units.

3. The robot joint driving apparatus according to claim 2, further comprising a plurality of guide units guiding the rectilinear movement of the pair of movable members.

4. The robot joint driving apparatus according to claim 3, wherein the guide units respectively include a plurality of sub ball screw units in movable contact with the pair of ball screw units, and the pair of movable members are respectively screw-connected to the sub ball screw units.

5. The robot joint driving apparatus according to claim 3, wherein the guide units respectively include a plurality of guide bars disposed in parallel with the plurality of ball screw units, and the guide bars guide the rectilinear movement of the pair of movable members.

6. The robot joint driving apparatus according to claim 1, wherein the pair of ball screw units isin movable contact with the driving motor, and is rotated according to the driving of the driving motor.

7. The robot joint driving apparatus according to claim 2, further comprising a belt unit to transmit the driving force of the driving motor to the pair of ball screw units.

8. A robot joint driving apparatus comprising:
a driving unit including a driving motor and a gear unit connected to the driving motor;
a pair of ball screw units in movable contact with the gear unit;
a pair of movable members respectively provided at the pair of ball screw units, and moving rectilinearly in mutually opposite directions according to the rotation of the driving motor;
a wire provided with both ends of the wire being respectively connected to the pair of movable members, and moving according to the movement of the pair of movable members; and
a joint unit driven by the movement of the wire.

9. The robot joint driving apparatus according to claim 8, wherein the wire surrounds one side of the outer circumferential surface of the joint unit while maintaining a designated tensile force.

10. The robot joint driving apparatus according to claim 8, further comprising guide units guiding the rectilinear movement of the pair of movable members.

11. The robot joint driving apparatus according to claim 10, wherein the guide units respectively include a plurality of sub ball screw units in movable contact with the pair of ball screw units, and the pair of movable members is screw-connected to the pair of sub ball screw units.

12. The robot joint driving apparatus according to claim 10, wherein the guide units respectively include guide bars disposed in parallel with the pair of ball screw units, and the guide bars guide the sliding movement of the pair of movable members.

13. A robot joint driving apparatus comprising:
a driving motor being rotatable in first and second directions;
a first ball screw unit provided with a first movable member connected to the driving motor and moving rectilinearly according to the rotation of the driving motor in a first direction;
a second ball screw unit provided with a second movable member connected to the driving motor and moving rectilinearly in a direction opposite to the direction of the movement of the first movable member according to the rotation of the driving motor in the first direction;
a wire connected to the first and second movable members; and
a joint unit rotatably connected to the wire according to the movement of the wire, and rotated according to the driving of the driving motor.

14. A robot comprising:
a joint unit; and
a joint driving apparatus to drive the joint unit, the joint driving apparatus comprising:
a driving motor;
a pair of movable members connected to the driving motor, and
moving rectilinearly in mutually opposite directions according to the rotation of the driving motor; and
a wire connecting the pair of movable members and the joint unit to rotate the joint unit according to the movement of the pair of movable members while maintaining a designated tensile force.

15. The robot according to claim 14, wherein the joint driving apparatus further comprises a pair of ball screw units, and each of the pair of movable members is respectively connected to one of the pair of ball screw units.

16. The robot according to claim 14, wherein the joint driving apparatus further comprises guide units guiding the rectilinear movement of the pair of movable members.

17. The robot according to claim 16, wherein the guide units each include sub ball screw units in movable contact with the pair of ball screw units, and the pair of movable members are respectively screw-connected to the sub ball screw units.

18. The robot according to claim 16, wherein the guide units each include guide bars respectively disposed in parallel with the pair of ball screw units, and the guide bars guide the sliding movement of the pair of movable members.

19. The robot according to claim 14, wherein the pair of ball screw units are in movable contact with the driving motor, and are rotated according to the driving of the driving motor.

20. The robot according to claim 14, wherein each of the at least one joint driving apparatus further comprises a belt unit to transmit the driving force of the driving motor to the pair of ball screw units.

21. A robot comprising:
a joint unit; and
a joint driving apparatus to drive the joint unit, the joint driving apparatus comprising:
a driving motor being rotatable in first and second directions;
a first ball screw unit provided with a first movable member connected to the driving motor, and moving rectilinearly according to the rotation of the driving motor in the first direction;
a second ball screw unit provided with a second movable member connected to the driving motor, and moving rectilinearly in a direction opposite to the direction of movement of the first movable member according to the rotation of the driving motor in the first direction; and
a wire connected to the first and second movable members,
wherein each of the joint units is rotatably connected to the wire according to the movement of the wire, and is rotated according to the driving of the driving motor.
